(19) United States
(12) Patent Application Publication
(10) Pub. No.: US 2013/0047444 A1
(43) Pub. Date: Feb. 28, 2013

(54) GEARED MELON PEELER

(71) Applicant: THOMAS IENTILE, Brielle, NJ (US)

(72) Inventor: THOMAS IENTILE, Brielle, NJ (US)

(21) Appl. No.: 13/214,735

(22) Filed: Aug. 22, 2011

(51) Int. Cl. A47J 17/02

(52) U.S. Cl. 30/280

(57) ABSTRACT

A geared kitchen utensil for peeling melon fruit from a melon rind is presented. The utensil has a handle member and U-shaped base member. A spring loaded rotatable cutting blade is mounted between two arms of the U-shaped base member. The cutting blade is mounted by means of a rotating shaft to a series of toothed sprockets. The toothed sprockets allow the device to be rotated to achieve the cutting depth into the melon and protect the user from being cut by the blade.

### BACKGROUND OF THE INVENTION

The present invention is directed to the field of household kitchen utensils. In particular, the present invention is directed to an improved device for removing the edible fruit portion of a melon from the rind of a melon.

The available utensils for removing fruit from the rind of a melon include knives as well as other specially designed utensils. The available devices suffer from various defects including the inability to remove the fruit from the rind in a controlled manner. In addition, many of the available utensils create safety issues due to the potential that the user may be cut by a sharp blade.

The primary object of the present invention is to provide a solution for the various defects in the available utensils. Thus, the present invention is directed to a device that allows the user to quickly and safely remove the fruit portion from the rind of a melon at a controlled depth. In addition, the present invention operates in a manner which keeps the user's fingers safely away from the cutting blade.

### SUMMARY OF INVENTION

A utensil for removing edible fruit from the rind of a fruit comprising a handle member; a base member extending from the handle member a cutting blade rotatably mounted to the base member; a spring mounted to the base member and the cutting blade so that the cutting blade can be reversibly rotated between a first position and a second position; and a plurality of interconnected toothed sprockets rotatably mounted to the base member and to the cutting-blade wherein the utensil is placed in contact with a cutting surface and the handle member is rotated and the plurality of interconnected toothed sprockets are engaged so that cutting blade engages to allow the fruit to be cut from the rind to a user-selected depth.

### BRIEF DESCRIPTION OF THE DRAWINGS

FIG. 1 is a partial cut-away side plan view illustrating an embodiment of the present invention.

FIG. 2 is a partial side plan view illustrating an embodiment of the present invention.

FIG. 3 is a partial cut-away rear plan view of an embodiment of the present invention.

FIG. 4 is a rear isometric view of an embodiment of the present invention.

FIG. 5 is a front isometric view of an embodiment of the present invention.

FIG. 6 is a front isometric view illustrating the use of an embodiment of the present invention.

### DETAILED DESCRIPTION OF THE PRESENT INVENTION

The presently preferred embodiment of the present invention as illustrated in the drawings will now be described. Those of ordinary skill in the art will recognize that many obvious variations may be made to this embodiment without departing from the spirit or scope of the present invention.

The geared melon peeler 10 of the present invention is illustrated in the drawings. The peeler 10 comprises a longitudinally extending handle member 12 extending to a generally u-shaped base member 14. The base member 14 comprises two arm members 16 and 18.

A cutting blade 20 is mounted near the center of the u-shaped base member 14 between the two arm members 16 and 18. The cutting blade 20 is rotatably mounted to a spring 22 on arm 16. The cutting blade 20 may be rotated approximately 75 degrees from a first position to a second position. As explained below, the spring 22 automatically returns the cutting blade 20 to the first position when it is displaced therefrom.

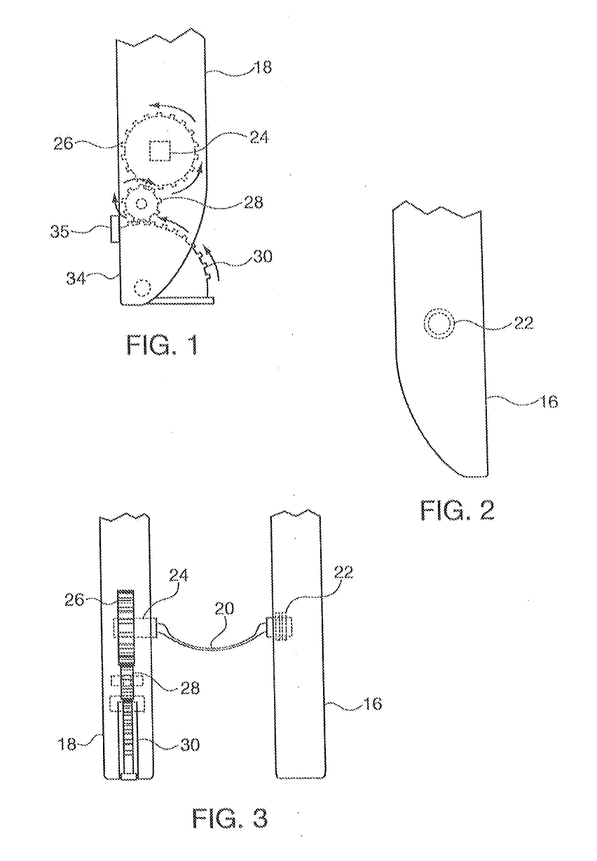

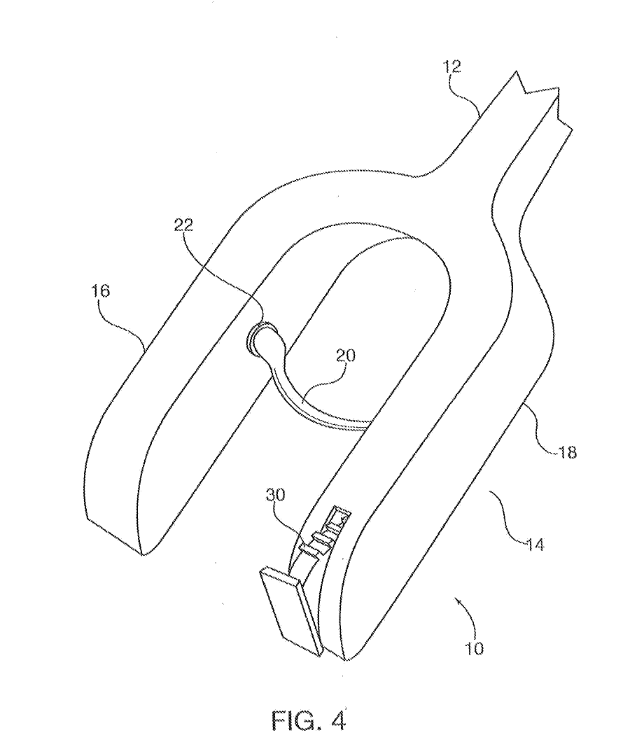

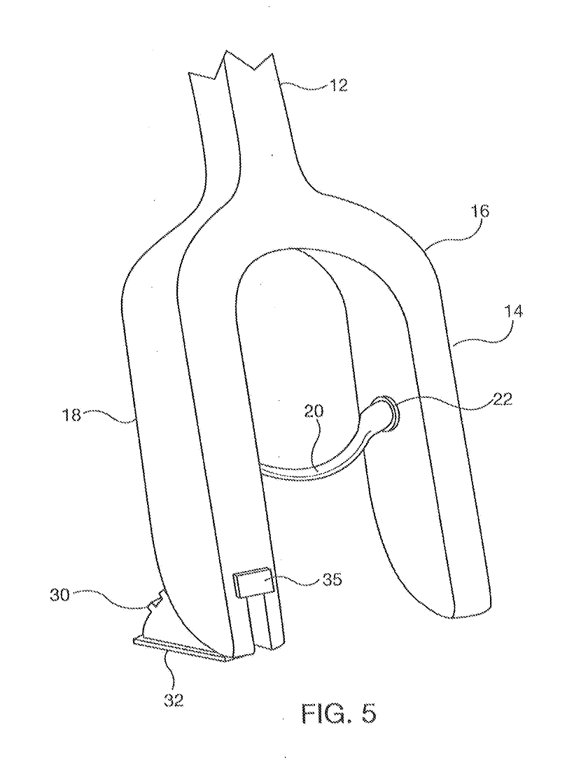

The cutting blade 20 is rotatably mounted through an opening on arm 18 to a rotatable shaft 24. A first toothed sprocket 26 is disposed on the end of shaft 24 opposite to the cutting blade 20. The first toothed sprocket 26 engages a second rotating toothed sprocket 28 which in turn engages a third rotating toothed sprocket 30. As shown in FIG. 1, the third toothed sprocket 30 comprises approximately one-fourth of a circle. The sprocket 30 further comprises two flat surfaces 32 and 34 as shown in FIGS. 1 and 5. The flat surface 32 is meant to contact a cutting surface. The rotating toothed sprocket 30 further comprises a stop 35.

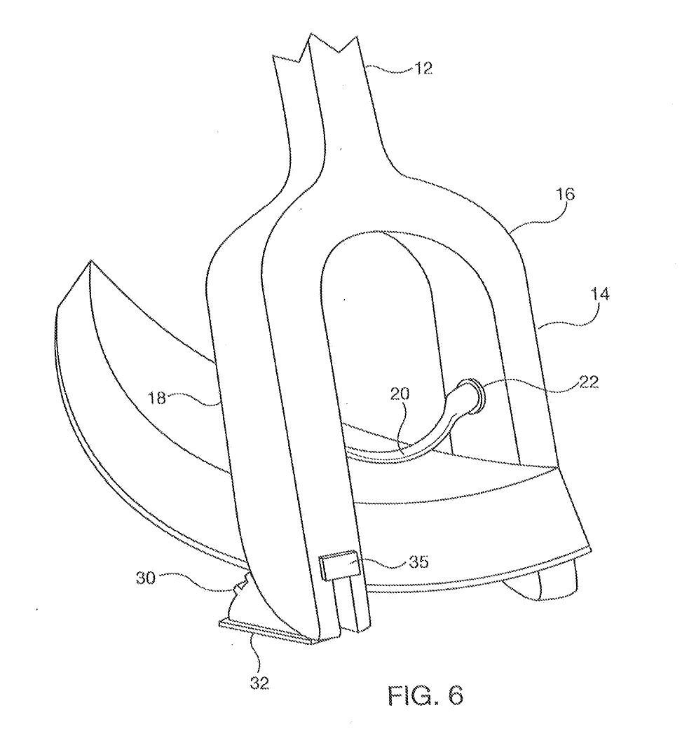

In use, the cutting surface could be the fruit of a melon such as illustrated in FIG. 6. The cutting blade depth can be easily changed by either lifting or lowering the handle member 12 to or from the cutting surface. Moving the handle towards the cutting surface while simultaneously maintaining contact with the cutting surface increases the depth of cut and conversely, lifting the handle away makes for a thinner slice cut.

This is made possible by the three toothed sprockets 26, 28 and 30 which determine the position of the cutting blade 20. Further the spring 22 maintains pressure on the cutting blade and returns it to the first position. With the peeler 10 in contact with the cutting surface, as the handle member 12 is brought closer to the cutting surface (increasing the depth of cut) the toothed sprocket 30 in direct contact with the cutting surface, activates the second rotating toothed sprocket 28, which in turn, activates the first toothed sprocket 26, thereby keeping the cutting blade 20 parallel to the cutting surface. Besides the sprocket design, the blades parallel consistency is achieved by the spring 22 applying a constant force to return all the moving parts to the first position. The stop 35 contacts the rear of arm 18 to prevent the toothed sprocket 30 from moving too far into the fruit.

Those of ordinary skill in the art will recognize that the foregoing merely represents one embodiment of the present invention and many obvious modifications may be made thereto without departing from the spirit or scope of the present invention as set forth in the appended claims.

What is claimed is a:

1. A utensil for removing edible fruit from the rind of a fruit comprising:
a) a handle member;
b) a base member extending from the handle member;
c) a cutting blade rotatably mounted to the base member;
d) a spring mounted to the base member and the cutting blade so that the cutting blade can be reversibly rotated between a first position and a second position; and
e) a plurality of interconnected toothed sprockets rotatably mounted to the base member and to the cutting-blade;
wherein the utensil is placed in contact with a cutting surface and the handle member is rotated and the plurality of interconnected toothed sprockets are engaged so that cutting blade engages to allow the fruit to be cut from the rind to a user-selected depth.

2. The utensil of claim 1 wherein the base member comprises a first arm and a second arm that are generally parallel and the cutting blade is mounted tranversely between the first and second parallel arms.

3. The utensil of claim 2 wherein the spring is mounted to the first arm.

4. The utensil of claim 3 wherein the plurality of interconnected toothed sprockets are mounted to a rotatable shaft in the second arm.

5. The utensil of claim 1 wherein one of the plurality of interconnected toothed sprockets is formed as approximately one-fourth of a circle with two flat surfaces wherein one of the flat surfaces is adapted to contact the cutting surface during use and the handle member is rotated relative to the cutting surface to vary the depth of the cut and the second flat surface has a stop mounted thereon to prevent movement of the utensil beyond a predetermined position.

6. The utensil of claim 5 wherein the plurality of interconnected toothed sprockets comprises three toothed sprockets.
